(19) United States
(12) Patent Application Publication
(10) Pub. No.: US 2021/0144047 A1
(43) Pub. Date: May 13, 2021

(54) OPERATIONAL ANOMALY FEEDBACK LOOP SYSTEM AND METHOD

(71) Applicant: AVEVA SOFTWARE, LLC, Lake Forest, CA (US)

(72) Inventors: Brian Kenneth Erickson, Long Beach, CA (US); Vinay T. Kamath, Rancho Santa Margarita, CA (US); ArunKumar Nattamai Ramdoss, Mission Viejo, CA (US); Elliott Scott Middleton, Tyler, TX (US)

(21) Appl. No.: 17/096,114

(22) Filed: Nov. 12, 2020

Related U.S. Application Data
(60) Provisional application No. 62/934,041, filed on Nov. 12, 2019.

(51) Int. Cl. H04L 12/24

(52) U.S. Cl. CPC H04L 41/064; H04L 41/22

(57) ABSTRACT

Disclosed are systems and methods for improving interactions with and between computers in content providing, searching and/or hosting systems supported by or configured with devices, servers and/or platforms. The disclosed systems and methods provide a novel framework that automatically detects and provides dynamically determined and automatically compiled anomaly information in and/or associated with an online distributed operation environment. The disclosed framework is configured to analyzing systems data to determine electronic information related to anomalies, and compile and present a user interface that relays this information. In response to detected feedback to the presented data, such data is feedback to the framework for customization of the data, which is then automatically provided to the viewer as an updated interface display.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### CROSS-REFERENCE TO RELATED APPLICATIONS

This application claims the benefit of priority from U.S. Provisional Application No. 62/934,041, filed Nov. 12, 2019, entitled “Operational Anomaly Feedback Loops System And Server,” which is incorporated herein by reference in its entirety.

### FIELD

Some embodiments relate generally to improving the performance of network-based computerized content hosting and providing devices, systems and/or platforms by modifying the capabilities and providing non-native functionality to such devices, systems and/or platforms through a novel and improved asset management framework for automatically detecting and providing dynamically determined and automatically compiled anomaly information in and/or associated with an online distributed operation environment.

### BACKGROUND

As more data get logged into databases, cloud servers, operational historians and/or any other type of software-based and hardware supported local and/or network configured data store(s), customers, and the systems and services associated therewith, are looking for computerized mechanisms for managing, understanding and providing the data.

Conventional mechanisms are failing, as they are leading to loss of data, increased bottlenecking and inefficiency in data reception and presentation, and an overall lack of organization in the way the data is protected and provided to permitted users.

### SUMMARY

Thus, the existing technological failings in the computerized fields of data storage, retention and presentation are currently lacking online or computerized mechanisms that enable automatic, dynamically determined and updated interactions to facilitate how and which manner the data is compiled, presented and/or interacted with. The disclosed systems and methods, among other features, provide the disclosed asset management framework to address these needs and more.

According to some embodiments, the disclosed framework executes systems and methods that perform unsupervised anomaly detection on received and/or identified data, and automatically generates output that reports the analyses results for consumption.

In some embodiments, as discussed in more detail below, the output data can be formatted in accordance with any type of known or to be known type or form of electronic and/or digital content that are presentable within an application's user interface (UI), such as, but not limited to, electronic documents, electronic messages, interface objects, multimedia, and the like. The presentation of such data enables users to drill down on and take action and the data, either as a whole or in part (e.g., interact with specific portions of the data).

In some embodiments, such input, “drilling down” or interactions with the data can include, but is not limited to, requesting additional data, performing additional or supplemental analysis on the data, expanding the data, retrieving third party or external data about the data that augments or supplements the data, modifying how the data is displayed, deleting the data, resetting the data, and the like or some combination thereof.

According to some embodiments, the input provided to or received in association with the displayed data to the user can be leveraged into input for a feedback loop specifically configured for the novel framework disclosed herein. The feedback loop provides a user, client or customer (used interchangeably) a recursive pipeline back to the compiled and presented data, which, as discussed in more detail below, enables the data to updated, modified and/or supplemented in order to provide a more customized (e.g., personalized) experience via the UI.

Thus, in some embodiments, items, sets or objects of data (e.g., referred to as “news stores” of separate data or content events) can be compiled, generated, built and dynamically updated as data is received (e.g., as a story “unfolds” or as new related data is received) and based on and user feedback, thereby providing a personalized user experience that mirrors interests explicitly or implicitly provided to the framework.

By way of a non-limiting example, data collected from a plant indicates that a key tool (e.g., an asset) is having issues handling operations beyond a certain pressure value. This data can be compiled and send to the user within the UI. Each time the pressure exceeds the critical value, a new data item can be compiled and sent to the UI to update the “story” about the anomaly occurring.

In some embodiments, incorporating user feedback loops into generated, newly created and/or updated stories provides a capability to identify what the user is interested in. For example, a user may be interested in a Tag, an Asset, a location, kind or type of anomaly, anomaly severity and its relevance to the user, and the like, or some combination thereof. Such feedback not only helps the quality of the anomalies being reported to the user but also improves the metrics that are used to detect and report these anomalies.

By way of a non-limiting example, continuing with the above example, the user, upon viewing the UI, requests information about the settings of the asset when the pressure value is surpassing the critical value. This information can be retrieved and added to the UI so as to supplemental the data already included therein, thereby providing a further development to the story being depicted within the UI.

According to some embodiments, the instant disclosure provides methods and systems for providing asset management and visualization. Some embodiments of the instant disclosure involves composing selected data based on asset metrics, and rendering a display that conveys a unified, asset-centric analytics user interface.

As a non-limiting example, some industrial sites employ hundreds or thousands of assets to carry out industrial operations. Ensuring the correct operation of assets is critical to managing an industrial site. Assets may experience several issues such as unscheduled downtime, failure, defects, maintenance, unproductivity, and other issues that affect the efficiency and workflow of the industrial site. Thus, in some embodiments, the disclosed systems and methods provide a framework for the detection and customized presentation of such data in an updated and/or recursive manner.

Some embodiments comprise collection of user feedback on the anomalies, and the subsequent generation and upkeep of scores. Such scores, as discussed in more detail below, provide a dynamically determined representation of what a user, set of users, or other asset or user type are interested in and/or have expressed interest in.

In some embodiments, a score can be a numerical value, and in some embodiments, a score can be a digital representation of user received and/or interactive with data, such as, but not limited to, a feature vector.

For example, a user can be presented asset data within a UI. In response, the user can provide feedback, which for example, can be a “thumbs up” or “thumbs down” on particularly presented data item.

Some embodiments comprise modification of relevance score based on tag, asset type, anomaly type, and/or severity. Some embodiments include the modification being based on, and/or additionally based on, the feedback provided by the viewing entity. Thus, in some embodiments, information related to a user, team, asset, asset type, location(s), solution feedback, and the like, or some combination thereof, can be taken into consideration for compiling and/or updating a relevance score. Some embodiments comprise personalization to the user and aggregated to teams. In some embodiments, scores for particular assets, anomalies, users, teams, locations, time periods, and the like, can be weighted, and can be based on system and/or user story type.

According to some embodiments, the instant disclosure provides systems and methods for implementing a novel and improved asset management framework for automatically detecting and providing dynamically determined and automatically compiled anomaly information in and/or associated with an online distributed operation environment.

According to some embodiments, a method comprises: receiving, by a computing device, data related to an operation by an asset at a location for a time period; analyzing, by the computing device, the data, and based on the analysis, identifying anomaly information identified by the data; causing to be displayed, via the computing device over a network, the anomaly information within a user interface (UI), the UI enabling interaction and input corresponding to the displayed anomaly information; receiving, by the computing device, in response to display of the anomaly information within the UI, feedback, the feedback comprising information indicating a type of request in response to viewing the anomaly information within the UI; analyzing, by the computing device, the anomaly information based on the feedback, and determining, based on the analysis, a story score, the story score corresponding to the operation at the location; and causing an update, by the computing device, of the anomaly information displayed within the UI based on the determined story score, the update comprising an action that corresponds to a type of request indicated by the feedback.

In some embodiments, the method further comprises: determining, based on analysis of the anomaly information, attributes of the anomaly information identified via the feedback, wherein the story score is further based on the attributes.

In some embodiments, the method further comprises: receiving a second set of data related to another operation by the asset at the location; and updating the story score based on the second set of data, wherein display of the second set of data is based at least in part on the feedback. In some embodiments, the second set of data is received based on the feedback.

In some embodiments, the method further comprises: generating an electronic data object based on the identified anomaly information, the electronic data object comprising displayable and interactive information digitally representing at least the anomaly information. In some embodiments, the type of electronic data object is based at least in part on a type of anomaly information, the type of anomaly information dictating how to display the anomaly information within the UI.

In some embodiments, the type of request indicated by the feedback comprises at least one of a like, dislike, reset or expand.

In some embodiments, the anomaly information comprises information related to at least one instance of the operation by the asset that caused an anomaly of data within the received data. In some embodiments, the anomaly information further comprises additional information related to remaining data in the received data. In some embodiments, the additional information comprises data and metadata related to at least one of the operation, a user, a team, the asset and the location.

In some embodiments, the feedback is provided by a user viewing the UI on a device of the user.

Some embodiments provide a non-transitory computer-readable storage medium for carrying out the above mentioned technical steps of the framework's functionality. The non-transitory computer-readable storage medium has tangibly stored thereon, or tangibly encoded thereon, computer readable instructions that when executed by a device (e.g., application server, messaging server, email server, ad server, content server and/or client device, and the like) cause at least one processor to perform a method for a novel and improved framework for automatically detecting and providing dynamically determined and automatically compiled anomaly information in and/or associated with an online distributed operation environment.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 is a schematic diagram illustrating an example of a network within which the systems and methods disclosed herein could be implemented according to some embodiments of the present disclosure;

FIG. 3 depicts is a schematic diagram illustrating an example of client device according to some embodiments of the present disclosure;

FIG. 4 is a block diagram illustrating components of an exemplary system in accordance with embodiments of the present disclosure;

FIGS. 5A-5B illustrate non-limiting examples of an application's user interface (UI) according to some embodiments of the present disclosure; and

FIG. 6 details a non-limiting data flow according to some embodiments of the present disclosure.

### DESCRIPTION OF EMBODIMENTS

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, cloud storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4^{th} or 5^{th} generation (2G, 3G, 4G or 5G) cellular technology, Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments will now be described in greater detail with reference to the figures. In general, with reference to FIG. 1, a system 100 in accordance with some embodiments of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)—network 105, wireless network 110, mobile devices (client devices) 102-104 and client device 101. FIG. 1 additionally includes a variety of servers, such as content server 106 and application (or “App”) server 108.

Some embodiments of mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information, as discussed above.

Mobile devices 102-104 also may include at least one client application that is configured to receive content from another computing device. In some embodiments, mobile devices 102-104 may also communicate with non-mobile client devices, such as client device 101, or the like. In some embodiments, such communications may include sending and/or receiving messages, creating and uploading documents, searching for, viewing and/or sharing memes, photographs, digital images, audio clips, video clips, or any of a variety of other forms of communications.

Client devices 101-104 may be capable of sending or receiving signals, such as via a wired or wireless network, or may be capable of processing or storing signals, such as in memory as physical memory states, and may, therefore, operate as a server.

In some embodiments, wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104.

In some embodiments, network 105 is configured to couple content server 106, application server 108, or the like, with other computing devices, including, client device 101, and through wireless network 110 to mobile devices 102-104. Network 105 is enabled to employ any form of computer readable media or network for communicating information from one electronic device to another.

In some embodiments, the content server 106 may include a device that includes a configuration to provide any type or form of content via a network to another device. Devices that may operate as content server 106 include personal computers, desktop computers, multiprocessor systems, microprocessor-based or programmable consumer electronics, network PCs, servers, and the like. In some embodiments, content server 106 can further provide a variety of services that include, but are not limited to, email services, instant messaging (IM) services, streaming and/or downloading media services, search services, photo services, web services, social networking services, news services, third-party services, audio services, video services, SMS services, MMS services, FTP services, voice over IP (VOIP) services, or the like. Such services, for example the email services and email platform, can be provided via the message server 120.

In some embodiments, users are able to access services provided by servers 106 and 108. This may include in a non-limiting example, authentication servers, search servers, email servers, social networking services servers, SMS servers, IM servers, MMS servers, exchange servers, photo-sharing services servers, and travel services servers, via the network 105 using their various devices 101-104.

In some embodiments, application server 108, for example, can store various types of applications and application related information including application data and user profile information (e.g., identifying, generated and/or observed information associated with a user).

In some embodiments, content server 106 and app server 108 can store various types of data related to the content and services each provide, observe, identify, determine, generate, modify, retrieve and/or collect. Such data can be stored in an associated content database 107, as discussed in more detail below.

In some embodiments, server 106 and/or 108 can be embodied as a cloud server or configured for hosting cloud services, as discussed herein.

In some embodiments, the network 105 is also coupled with/connected to a Trusted Search Server (TSS) which can be utilized to render content in accordance with the embodiments discussed herein. Embodiments exist where the TSS functionality can be embodied within servers 106 and 108.

Moreover, although FIG. 1 illustrates servers 106 and 108 as single computing devices, respectively, the disclosure is not so limited. For example, one or more functions of servers 106 and 108 may be distributed across one or more distinct computing devices. Moreover, in some embodiments, servers 106 and 108 may be integrated into a single computing device, without departing from the scope of the present disclosure.

Additionally, while the illustrated embodiment in FIG. 1 depicts only servers 106 and 108, it should not be construed as limiting, as any type and number of servers can be included therein.

Turning to FIG. 2, computer system 210 is depicted and is a non-limiting example embodiment of system 100 discussed above in relation to FIG. 1.

FIG. 2 illustrates a computer system 210 enabling or operating an embodiment of system 100 of FIG. 1, as discussed below. In some embodiments, computer system 210 can include and/or operate and/or process computer-executable code of one or more of the above-mentioned program logic, software modules, and/or systems. Further, in some embodiments, the computer system 210 can operate and/or display information within one or more graphical user interfaces. In some embodiments, the computer system 210 can comprise a cloud server and/or can be coupled to one or more cloud-based server systems.

In some embodiments, the system 210 can comprise at least one computing device 230 including at least one processor 232. In some embodiments, the at least one processor 232 can include a processor residing in, or coupled to, one or more server platforms. In some embodiments, the system 210 can include a network interface 235a and an application interface 235b coupled to the least one processor 232 capable of processing at least one operating system 234. Further, in some embodiments, the interfaces 235a, 235b coupled to at least one processor 232 can be configured to process one or more of the software modules 238 (e.g., such as enterprise applications). In some embodiments, the software modules 238 can include server-based software, and can operate to host at least one user account and/or at least one client account, and operating to transfer data between one or more of these accounts using the at least one processor 232.

With the above embodiments in mind, it should be understood that some embodiments can employ various computer-implemented operations involving data stored in computer systems. Moreover, the above-described databases and models described throughout can store analytical models and other data on computer-readable storage media within the system 210 and on computer-readable storage media coupled to the system 210. In addition, the above-described applications of the system can be stored on non-transitory computer-readable storage media within the system 210 and on computer-readable storage media coupled to the system 210.

In some embodiments, the system 210 can comprise at least one non-transitory computer readable medium 236 coupled to at least one data source 237a, and/or at least one data storage device 237b, and/or at least one input/output device 237c. In some embodiments, the disclosed systems and methods can be embodied as computer readable code on a computer readable medium 236. In some embodiments, the computer readable medium 236 can be any data storage device that can store data, which can thereafter be read by a computer system (such as the system 210). In some embodiments, the computer readable medium 236 can be any physical or material medium that can be used to tangibly store the desired information or data or instructions and which can be accessed by a computer or processor 232. In some embodiments, at least one of the software modules 238 can be configured within the system to output data to at least one user 231 via at least one graphical user interface rendered on at least one digital display.

In some embodiments, the non-transitory computer readable medium 236 can be distributed over a conventional computer network via the network interface 235a where the system embodied by the computer readable code can be stored and executed in a distributed fashion. For example, in some embodiments, one or more components of the system 210 can be coupled to send and/or receive data through a local area network (“LAN”) 239a and/or an internet coupled network 239b (e.g., such as a wireless internet). In some further embodiments, the networks 239a, 239b can include wide area networks (“WAN”), direct connections (e.g., through a universal serial bus port), or other forms of computer-readable media 236, or any combination thereof.

In some embodiments, components of the networks 239a, 239b can include any number of user devices such as personal computers including for example desktop computers, and/or laptop computers, or any fixed, generally non-mobile internet appliances coupled through the LAN 239a. For example, some embodiments include personal computers 240a coupled through the LAN 239a that can be configured for any type of user including an administrator. Other embodiments can include personal computers coupled through network 239b. In some further embodiments, one or more components of the system 210 can be coupled to send or receive data through an internet network (e.g., such as network 239b). For example, some embodiments include at least one user 231 coupled wirelessly and accessing one or more software modules of the system including at least one enterprise application 238 via an input and output (“I/O”) device 237c. In some other embodiments, the system 210 can enable at least one user 231 to be coupled to access enterprise applications 238 via an I/O device 237c through LAN 239a. In some embodiments, the user 231 can comprise a user 231a coupled to the system 210 using a desktop computer, and/or laptop computers, or any fixed, generally non-mobile internet appliances coupled through the internet 239b. In some embodiments, the user 231 can comprise a mobile user 231b coupled to the system 210. In some embodiments, the user 231b can use any mobile computing device 231c to wirelessly coupled to the system 210, including, but not limited to, personal digital assistants, and/or cellular phones, mobile phones, or smart phones, and/or pagers, and/or digital tablets, and/or fixed or mobile internet appliances.

FIG. 3 is a schematic diagram illustrating a client device showing an example embodiment of a client device that may be used within the present disclosure. Client device 300 may include many more or less components than those shown in FIG. 3. However, the components shown are sufficient to disclose an illustrative embodiment for implementing the present disclosure. Client device 300 may represent, for example, client devices discussed above in relation to FIGS. 1-2.

As shown in FIG. 3, in some embodiments, Client device 300 includes a processing unit (CPU) 322 in communication with a mass memory 330 via a bus 324. In some embodiments, Client device 300 also includes a power supply 326, one or more network interfaces 350, an audio interface 352, a display 354, a keypad 356, an illuminator 358, an input/output interface 360, a haptic interface 362, an optional global positioning systems (GPS) receiver 364 and a camera(s) or other optical, thermal or electromagnetic sensors 366. Device 300 can include one camera/sensor 366, or a plurality of cameras/sensors 366, as understood by those of skill in the art. Power supply 326 provides power to Client device 300.

Client device 300 may optionally communicate with a base station (not shown), or directly with another computing device. Network interface 350 is sometimes known as a transceiver, transceiving device, or network interface card (NIC).

In some embodiments, audio interface 352 is arranged to produce and receive audio signals such as the sound of a human voice. Display 354 may be a liquid crystal display (LCD), gas plasma, light emitting diode (LED), or any other type of display used with a computing device. Display 354 may also include a touch sensitive screen arranged to receive input from an object such as a stylus or a digit from a human hand.

Keypad 356 may comprise any input device arranged to receive input from a user. Illuminator 358 may provide a status indication and/or provide light.

In some embodiments, client device 300 also comprises input/output interface 360 for communicating with external. Input/output interface 360 can utilize one or more communication technologies, such as USB, infrared, Bluetooth™, or the like. In some embodiments, haptic interface 362 is arranged to provide tactile feedback to a user of the client device.

Optional GPS transceiver 364 can determine the physical coordinates of Client device 300 on the surface of the Earth, which typically outputs a location as latitude and longitude values. GPS transceiver 364 can also employ other geo-positioning mechanisms, including, but not limited to, triangulation, assisted GPS (AGPS), E-OTD, CI, SAI, ETA, BSS or the like, to further determine the physical location of Client device 300 on the surface of the Earth. In some embodiments, however, Client device may through other components, provide other information that may be employed to determine a physical location of the device, including for example, a MAC address, Internet Protocol (IP) address, or the like.

In some embodiments, mass memory 330 includes a RAM 332, a ROM 334, and other storage means. Mass memory 330 illustrates another example of computer storage media for storage of information such as computer readable instructions, data structures, program modules or other data. Mass memory 330 stores a basic input/output system (“BIOS”) 340 for controlling low-level operation of Client device 300. The mass memory also stores an operating system 341 for controlling the operation of Client device 300.

In some embodiments, memory 330 further includes one or more data stores, which can be utilized by Client device 300 to store, among other things, applications 342 and/or other information or data. For example, data stores may be employed to store information that describes various capabilities of Client device 300. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 300.

In some embodiments, applications 342 may include computer executable instructions which, when executed by Client device 300, transmit, receive, and/or otherwise process audio, video, images, and enable telecommunication with a server and/or another user of another client device. In some embodiments, applications 342 may further include search client 345 that is configured to send, to receive, and/or to otherwise process a search query and/or search result.

Having described the components of the general architecture employed within some embodiments, the components' general operation with respect to some embodiments will now be described below.

FIG. 4 is a block diagram illustrating the components of some embodiments. FIG. 4 includes feedback engine 400, network 415 and database 420. The feedback engine 400 can be a special purpose machine or processor and could be hosted by a cloud server (e.g., cloud web services server(s)), messaging server, application server, content server, social networking server, web server, search server, content provider, third party server, user's computing device, and the like, or any combination thereof.

According to some embodiments, feedback engine 400 can be embodied as a stand-alone application (e.g., referred to as a vision App) that executes on a server and/or user device (e.g., on a cloud server and/or on-prem on a user device or local storage). In some embodiments, the feedback engine 400 can function as an application installed on a device; and, in some embodiments, such application can be a web-based application accessed by a device over a network.

The database 420 can be any type of database or memory, and can be associated with a content server on a network (e.g., content server, a search server or application server) or a user's device (e.g., client/mobile devices from FIGS. 1-3). Database 420 comprises a dataset of data and metadata associated with local and/or network information related to users, services, applications, content and the like. Such information can be stored and indexed in the database 420 independently and/or as a linked or associated dataset. As discussed above, it should be understood that the data (and metadata) in the database 420 can be any type of information and type, whether known or to be known, without departing from the scope of the present disclosure.

According to some embodiments, database 420 can store data and metadata associated with users, operations, tasks, assets, files, projects, versions, synchronization events, schedules, images, videos, text, messages, products, items and services from an assortment of media and/or service providers and/or platforms, and the like.

As discussed above, with reference to FIGS. 1-2, the network 415 can be any type of network such as, but not limited to, a wireless network, a local area network (LAN), wide area network (WAN), the Internet, or a combination thereof. The network 415 facilitates connectivity of the feedback engine 400, and the database of stored resources 420. Indeed, as illustrated in FIG. 4, the feedback engine 400 and database 420 can be directly connected by any known or to be known method of connecting and/or enabling communication between such devices and resources.

The principal processor, server, or combination of devices that comprises hardware programmed in accordance with the special purpose functions herein is referred to for convenience as feedback engine 400, and includes data module 402, anomaly module 404, presentation module 406 and input module 408. It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed below.

FIGS. 5A-5B illustrates an example embodiment of engine 400's capabilities and functionality according to some embodiments of providing an interactive UI, as discussed herein. FIGS. 5A-5B illustrate non-limiting example embodiments that are discussed in more detail below in relation to FIG. 6.

As depicted in FIG. 5A, UI 500 depicts data collected for a specific event and for a predetermined time period. The example event being the cloud cover for an area (e.g., Dallas, Tex.) and the time period being October 20-24. These variables are portrayed via a plotting of the cloud values across an x-y axis.

UI 100 includes interactive items 502 and 504. These items are example embodiments of how a user can interact and provide feedback for provided/received data. For example, item 502 indicates that the information was “useful” and that more information in this manner, according to the same values and/or of the same type are being requested. To the contrary, for example, item 504 indicates it was not “useful”; therefore, other types, quantities and/or varieties of data are requested.

FIG. 5B illustrates another example with UI 512 providing data for humidity for a location over a period of time. UI 510 provides items 512 and 514, which have the same functionality as items 502 and 504 from FIG. 5A. UI 510 also illustrates additional functionality where the source of the data can be depicted. Item 516. This character item 516 can be a hyperlink or associated with a URL or other network resource that enables additional information to be retrieved related to the data displayed within UI, as discussed herein.

In some embodiments, UIs 500 and 510 can depict the data (e.g., the plotting of the dots on the x-y axis) in an interactive manner. For example, a user can select a specific value (e.g., dot), which can then act as a link to additional data that can be locally retrieved and displayed within a UI, and/or can be searched for and identified over a network and displayed within the UI (and/or within a separate window/interface).

Turning now to FIG. 6, Process 600 details a non-limiting embodiment according to some embodiments for automatically detecting and providing dynamically determined and automatically compiled anomaly information in and/or associated with an online distributed operation environment. According to some embodiments, the disclosed framework is configured to analyzing systems data to determine electronic information related to anomalies, and compile and present a user interface that relays this information. In response to detected feedback to the presented data, such data is feedback to the framework for customization of the data, which is then automatically provided to the viewer as an updated interface display.

In some embodiments, traditional condition monitoring can be fixed based on configured metrics. In some embodiments, unsupervised algorithms can dynamically identify anomalies. In some embodiments, feedback loops in this case not only provide a better way of presenting the data to the user and/or their team, but can also improve the learning of the system to improve the quality of the content presented to them over time.

Some embodiments comprise user feedback to news items specifications. Some embodiments comprise implemented components for integration of meaningful user feedback capability to news stories. In some embodiments, meaningful types of feedback can comprise: more and/or less news for a tag, more and/or less news (e.g. “more MTA”), and raise and/or lower threshold for news (e.g. more/less sensitive). In some embodiments, the combination of a tag and anomaly can be interesting and/or unimportant. In some embodiments, when an anomaly happens, it can be good and/or bad.

In some embodiments, user feedback can be provided by a user on a news story. In some embodiments, two documents can be created for each user feedback action provided by a user on a news story. In some embodiments, documents can be stored under a “news” collection (“news_tg” in case of dedicated tenant) of “ManagedHistorian” database.

An example of news_feedback for can comprise:

[
{
“id”: “a1e93448-ef23-4880-a30f-32f4ee117da0”,
“userid”: “miguel.tn2@outlook.com”,
“tenantid”: “b08e5177-127f-4b0d-a5a2-9e50741e7495”
“partitionid”: “b08e5177-127f-4b0d-a5a2-

9e50741e7495_miguel.tn2@outlook.com_News_Feedback”,

“feedback”: “Like”,
“_rid”: “GN8pANqmIAvdWgAAAAAAAg==”,
“_self”:

“dbs/GN8pAA==/colls/GN8pANqmIAs=/docs/GN8pANqmIAvdWgAAAAAAAg==/”,

“_etag”: “\“3400986e-0000-0700-0000-5d2e719e0000\””,
“_attachments”: “attachments/”,
“_ts“: 1563324830
}
]

In some embodiments, this document can store a user's feedback, (e.g., like and/or dislike). In some embodiments, this document can be used to indicate the status of the feedback for each news within a UI of a cloud platform, for example, on Insight® software UI.

An example of a news score for scoring logic can comprise:

[

{

“id”: “34b2f718-a558-4d85-b26c-f027d7fcff16”,
“tenantid”: “b08e5177-127f-4b0d-a5a2-9e50741e7495”,
“partitionid”: “b08e5177-127f-4b0d-a5a2-9e50741e7495_News_Score”,
“fqn”: “YashDNews.test_entropyhighnew”,
“algorithm”: “enta”,
“time”: “2019-07-17T00:53:50.070Z”,
“userid”: “miguel.tn2@outlook.com”,
“eventtype”: “Feedback”,
“eventvalue”: “Like”,
“_rid”: “GN8pANqmIAsOfQAAAAAADg==”,
“_self”:

“dbs/GN8pAA==/colls/GN8pANqmIAs=/docs/GN8pANqmIAsOfQAAAAAADg==/”

“_etag”: “\“2e00e771-0000-0700-0000-5d2e719e0000\””,
“_attachments”: “attachments/”,
“_ts”: 1563324830

}

]

TABLE 1

| Field | Description | Type | Source |
|---|---|---|---|
| id | Cosmos DB document id GUID | String | NewsId/New |
| | | | GUID |
| userid | User email id | String | userPrincipal |
| partitionid | For a cloud platform (e.g., Insight ®): | String | |
| | tenantid_userId_News_Feedback | | |
| | For Score: tenantid_News_Score | | |
| feedback | The type of feedback i.e. Like/Dislike | Enum | Request Payload |
| eventtype | Type of event i.e. Feedback/UserEvent | Enum | Request payload |
| eventvalue | Value of event i.e. Like/Dislike/Click/ | Enum | Request payload |
| | Expand | | |
| fqn | Primary fully qualified name of a tag | String | News Document |
| algorithm | Type of anomaly of the news story | String | News Document |
| timestamp | Date and time when the feedback was | ISO8601 | DateTime.UtcNow |
| | received last for the combination of that | string | |
| | tag and anomaly | datetime | |

Some embodiments comprise scenarios. Some embodiments further comprise concurrency scenarios. In some embodiments, concurrency scenarios can follow cases. In some embodiments, concurrency scenarios can be handled by SQL API support for optimistic concurrency control (OCC) through HTTP entity tags, or ETags.

In some embodiments, a user can click the same feedback from two different machines at the same time. In some embodiments, a user can click different feedback from two different machines at the same time. In some embodiments, a user can consecutively click the same feedback repeatedly. In some embodiments, a user can consecutively click different feedback repeatedly. In some embodiments, there can be a limit or threshold of feedback provided by a particular user.

In some embodiments, user feedback can be received for the same combination of tag and anomaly multiple times. In some embodiments, a single news_feedback document can stay unchanged. In some embodiments, each time a news event is received, a new news_score document can be created with the same partition_id to keep history of the user activity.

In some embodiments, a user can change their news feedback from “like” to “dislike” or other indications of positive and negative feedback. In some embodiments, a single news_feedback document can stay and overwrite the feedback value to return the latest feedback received. In some embodiments, for each time a news event is received, a new news_score document can be created with same partition_id to keep history of the user activity.

In some embodiments, a tag, data source, or tenant can be deleted. In some embodiments, it is possible to delete all news_feedback and news_score documents for a deleted tag, data source, or Tenant.

Some embodiments comprise news story scoring logic. In some embodiments, retrieval for more than a predetermined number of news stories (for example, 12) generated within a predetermined time period (e.g., the last 3 days) can be sorted by scoring algorithm based on the type of algorithm, story score assigned by reporters, and the tag name of the news stories clicked by a user. In some embodiments, more or fewer than a predetermined number of stories (e.g., 12) can be generated. In some embodiments, if there are more than a predetermined number stories (e.g., 12), the stories can be scored on the fly and the system can present each of the predetermined number stories (e.g., 12) in a sorted manner as desired.

In some embodiments, the total score can be calculated out of a predetermined number, for example 100, based on following non-limiting parameters—Table 2:

| Parameter | Max Score | Source |
|---|---|---|
| Maximum Story Score Count | 200 | System |
| | | Parameters |
| Default Story Score | 50 | Code logic |
| Tisa algorithm | 100 | Code logic |
| Comment | 20 | Code logic |
| Rank | 50 | Code logic |
| Affinity | 50 | Code logic |

In some embodiments, for news, the algorithm can be “tisa”. In some embodiments, the score for “tisa” can be assigned equal to 100. In some embodiments, the algorithm can be “comment”. In some embodiments, the score for “comments” can be assigned equal to 20. In some embodiments, for other news, the scoring can be a total of 50% of rank score and 50% of affinity score.

In some embodiments, the rank can be calculated for a story based on algorithm name. In some embodiments, the story score assigned by reporters for that algorithm, for all tenants, can be sorted in ascending order and normalized based on its index to get a score out of 100. In some embodiments, affinity can be assigned a score of 100 if a fqn is found in clicks document and 0 if not found in clicks document.

In some embodiments, the affinity score can include scoring criteria out of 100. For example, feedback can be provided to a combination of tag and anomaly such as interesting/unimportant (i.e., “interesting” action is +40, “click through” is +20, and “unimportant” is −40).

In some embodiments, the feedback type can be determined using the “feedback” attribute from data storage structure. In some embodiments, if recent feedback can be provided, a score can be assigned out of +20 with a higher score to more recent news. In some embodiments, a higher score can be determined by calculating the timespan between the “timestamp” attribute of feedback from data storage structure and the current time or time of retrieval.

Some embodiments comprise more and/or less news for a tag or type of anomaly “learnt” from provided feedback. In some embodiments, tag and/or anomaly can be provided with “interesting” feedback assigned+20 and “unimportant” feedback assigned −20. In some embodiments, a tag, having a single tag name in array of “fqn” attribute, can have multiple anomaly values in array of “algorithm” attribute, based on feedback provided, for example: “interesting”, can be inferred that the user would like to see more news for that tag and the score can be assigned equal to +20.

Some embodiments comprise a news API. In some embodiments, request can equal PUT. In some embodiments, the success status code can equal a predetermined number (e.g., 200). In some embodiments, the failure status code can equal a predetermined number (e.g., 400) bad requests with message with a predetermined number (e.g., 500) of internal server errors with error messages.

Some embodiments comprise API signature. In some embodiments, API signature can comprise request payloads and “feedback like”.

An example of “feedback like” can comprise:

{

“NewsEventType”: “Feedback”,
“NewsEventValue”: “Like”

}

An example of “feedback dislike” can comprise:

{

“NewsEventType”: “Feedback”,
“NewsEventValue”: “Dislike”

}

An example of “feedback reset” can comprise:

{

“NewsEventType”: “Feedback”,
“NewsEventValue”: “Reset”

}

An example of “userevent click” can comprise:

{

“NewsEventType”: “UserEvent”,
“NewsEventValue”: “Click”

}

An example of “userevent expand” can comprise:

{

“NewsEventType”: “UserEvent”,
“NewsEventValue”: “Expand”

}

According to some embodiments of Process 600, Step 602 is performed by the data module 402 of feedback engine 400; Step 604 is performed by the anomaly module 404; Steps 606-608 are performed by the presentation module 406; and Steps 610-614 are performed by the input module 408.

Process 600 begins with Step 602 where data related to an operation(s) by an asset(s) at a location(s) is received. The data, as discussed above, can be for a task being performed by a tool or tools (e.g., assets) at a jobsite for a specific time period, a requested time period or a monitored time period. For example, as illustrated in FIG. 5A, the time period can be from October 20-24, and the asset can be a Peltier device, for example.

In Step 604, the received data is analyzed, and based on the analysis, anomaly information from the data is determined. The anomaly information can indicate a type or quantity of information that occurs outside of a given pattern or expected result, or outside expected or predict norms for an event, time period or particular task/operation.

In some embodiments, the anomaly information can also include the other data, or at least a portion of the other data, thereby providing a perspective as to how the anomaly or anomalies relates to the determined normal or predicted data (e.g., predicted behavior of the data, operation and/or tools/assets).

In some embodiments, the analysis of Step 604 can involve any type of known or to be known computational analysis technique, including but not limited to, vector analysis, data mining, computer vision, machine learning, neural network, artificial intelligence, predictive modeling, and the like, or some combination. In some embodiments, such computerized analysis can enable the visualization of such data in a uniform manner across devices via a displayed UI, as discussed above and below.

In some embodiments, the analysis of Step 604 can also involve analyzing the data to determine tags, metadata or other forms of information describing the operation, the asset(s), users performing the tasks/operations, location(s), and the like. For example, tags indicating assets, asset types, types of operations, identities of users, and the like, or some combination thereof.

In some embodiments, as a sub-process of Step 604, the identified data from the analysis of Step 604 can be stored in a database or data store on a network (e.g., cloud server or historian database (DB)), as discussed above.

In Step 606, the identified information from Step 604 can be compiled into an electronic data object for display within a user interface (UI). The compilation involves manipulating the data and changing its format into a displayable format such that the information/data is renderable as a visible representation of the data.

For example, the cloud cover data of FIG. 5A and humidity data of FIG. 5B were modified into the renderable electronic objects displayed within UIs 500 and 510, respectively.

In some embodiments, as additionally discussed above, the anomaly information can be embodied as visible content displayable within a UI. Such content can include, but is not limited to, electronic data objects, interactive interface objects, tiles or electronic cards, displayable and interactive graphs, multimedia presentations, electronic messages, images, augmented reality (AR) depictions, virtual reality (VR) depictions, videos, and the like, or some combination thereof.

For purposes of this discussion, electronic data objects in general will be used as a reference for displayed data, and FIGS. 5A-5B illustrate example interactive graphs; however, it should be construed as limiting, as any type of known or to be known interactive displayed data objects can represent the anomaly information without departing from the scope of the instant application.

In Step 608, the generated UI presentation is displayed on a device of a user. In some embodiments, the display can be in response to a request for data. In some embodiments, the display can be an updating of an already displayed presentation, where the update can be based on user feedback (as discussed below) and/or another retrieval or reception of data (from Step 602).

In some embodiments, Step 608 involves communication instructions along with the UI to a device over a network to display the UI and the electronic data object included therein. In some embodiments, the instructions may only accompany the electronic data object as the UI is being operated locally or accessed via the device by a network.

In Step 610, feedback is received respective to the displayed electronic data object. Example, non-limiting embodiments of received feedback are discussed above, at least in relation to FIGS. 5A-5B.

In some embodiments, the feedback can be related to, but is not limited to, indicating approval or “liking” the data, “disliking” the data, requesting additional data, performing additional or supplemental analysis on the data, expanding the data, retrieving third party or external data about the data that augments or supplements the data, modifying how the data is displayed, and the like or some combination thereof.

In Step 612, upon receiving the feedback, the data identified as part of the feedback is analyzed. Such analysis is performed in a similar manner as discussed above in relation to Step 604. As a result of the analysis of Step 612, attributes, characteristics or traits associated with the feedback data are identified.

In some embodiments, such attributes can include, but are not limited to, a type of data interacted with, a type of feedback, identity and/or type of user providing the feedback, location and/or device information related to where the feedback was provided (e.g., Internet Protocol (IP) address of the user and/or GPS of the device within which feedback was provided), value of data interacted with, an indication if other users are providing feedback on the same data or data type, a time and date of the feedback, frequency of feedback, how recent was the feedback, types of tags of the data being interacted with, tags of the feedback, type of algorithm triggered by the feedback, and the like, or some combination thereof.

In Step 614, a story score is determined, calculated, derived or otherwise computed. In some embodiments, the story score and the iterations of its updating are performed in the manner discussed above by computing and accounting for all or at least a portion of the parameters detailed in relation to Table 2.

Some embodiments involve the story score being computed based on the data identified by the feedback (e.g., feedback attributes). Some embodiments involve the story score being computed based on feedback by a single user and/or a set or aggregate of users.

In some embodiments, a story score can be computed based on the feedback attributes and the received feedback. For example, the attributes of the data identified by the input/feedback (e.g., feedback data from Step 612) and the actual feedback. For example, using FIG. 5A as a non-limiting example, a user interacts with a certain cloud cover value point—this data and its attributes are the feedback data—and the received feedback provides an indication as to whether, for example, if the data was liked or disliked.

In some embodiments, the story score (and the feedback data from Step 612) can be stored in association with the received data or anomaly data (as discussed above). This data can be stored as part of a data container or look-up table (LUT) within a data store (e.g., database 420) so that engine 400 can readily retrieve and process the data for subsequent loops through Process 600.

Process 600 provides functionality for a feedback loop configured asset management framework. Thus, as a result of Step 614, the data is fed back to the preceding processes for their recursive performance. Such recursive performance can occur at the conclusion of step 614, based upon a request from a user or administrator, upon another time period occurring that indicates additional data is to be received, upon the detection of another anomaly, and the like, or some combination thereof.

In some embodiments, the line recursively connecting Step 614 to Steps 602 and 604 illustrates that the data can be updated, refreshed and automatically displayed within the UI, as discussed above. This enables the UI to customize data, for example, per user, per team, per operation, per asset, per asset type, and the like. Such customization via the disclosed feedback of data enables the updating and modification of data on the back-end. Thus, during a refresh, or upon performing analysis of additional data, the data within the UI need only be updated (and not the previously stored data), thereby increasing the efficiency in which tile data is presented within a UI.

In some embodiments, particular types, portions or sets of data can be weighted. Such weighting can be based on the feedback provided by a user. This weighted data can then be leveraged into weighted scores that further indicate the particular types of stories (e.g., anomalies) the user is interested in.

Non-Limiting Example Use Cases

According to some embodiments, in accordance with the disclosed system and methods, below are a series of example use cases that provide real-world examples of how the disclosed framework is configured to operate:

| | |
|---|---|
| # | Description |

UC#1: Secure a story - Poster wants story to be for limited audience

| | |
|---|---|
| 1. | Lenka is looking at a line chart. |
| 2. | Lenka right clicks a point in the trend and selects “posts story” |
| 3. | Lenka gives the text “the memory usage appears to be leaking here” |
| 4. | She knows this is sensitive information, so she adds the location “/lake forest” to the story. |
| 5. | The story is saved as follows: |
| | location “/lake forest” |
| | author “Lenka” |
| | tagname “m101.memory” |
| 6. | This story can be viewed only by users in Lakeforest location |
| | fqn |
| | algorithm |
| | author |
| | posted_datetime (currently datetime) |
| | event_datetime |
| | event_span |
| | location |
| | caption |
| | body(html) |
| | tenant |
| | timezone |
| | units |
| | tz |

UC#2: New user creation story
This API is used admin to create new user story when a new user is signed up

| | |
|---|---|
| 1. | A new user, Bob, signs up to a plant automation software platform (e.g., Wonderware ®) |
| | online from Chicago |
| 2. | Bob enters his user name, password, First name and Last name to sign up. |
| 3. | A new story is created and saved in the database (DB) with following details. |
| | datetime |
| | tenant |
| | timezone |
| | caption: New user Bob signed up |
| | location: |
| | author: |

UC#3: Lenka shared the monthly widgets report with Organization and a new story gets
posted by a cloud platform (e.g., InSight ®)
Create a US to post for this event

| | |
|---|---|
| 1. | The user, Lenka, shared a report from a plant automation software platform (e.g., |
| | Wonderware ®) online with user Greg. |
| 2. | Wonderware online post a story in the news DB with following title. |
| | A story will be created during this activity |
| | In some embodiments, only Lenka/Greg see this story |
| 3. | |

UC#4: Click through to see all stories I've posted

| | |
|---|---|
| 1. | Greg logs in to a plant automation software platform (e.g., Wonderware ®) online and click |
| | on “stories I posted” link |
| 2. | All the storied created by Greg get listed. |
| | Select all user stories where author = ‘greg.clinton@abc.com’ |

UC#5: Click through to view Lenka's profile from story

| | |
|---|---|
| 1. | Greg opens the story created by Lenka. |
| 2. | He clicks the hyper link on author name. |
| 3. | Profile of Lenka gets displayed. |
| | Select user profile where user profile.id = story.author |

UC#6: Delete a story that I have posted

| | |
|---|---|
| 1. | Lenka navigates to one of the stories she has posted. |
| 2. | Lenka clicks on rescind button. |
| 3. | The story gets deleted from news DB or marked as deleted in the DB(deleted flag set to |
| | “yes”)· |
| | 1. User context needs to be passed (email address) |
| | 2. Validate user has privileges to delete based on email address |
| | 3. Delete story with matching with story _id (created by mongoDB), move the story to |
| | the “deleted stories” collection. |

UC#7: Show points on a graph with related stories to a tag being plotted on a line chart

| | |
|---|---|
| 1. | Lenka opens a line chart of “lakeforest” temperature. in time range t1 to t2 |
| 2. | In the graph all the points, to which stories are attached, are marked in dark “dot” |
| | SELECT WHERE FQN = ‘lakeforest.temparature’ and event_datetime >= t1 and |
| | event_datetime =< t2 |

UC#8: Hover over a story to see story title

| | |
|---|---|
| 1. | Lenka opens up line chart of “lakeforest” temperature. |
| 2. | In the graph all the points, to which stories are attached, are marked in dark “dot” |
| 3. | Lenka hover the mouse over the point corresponding to a story in the graph. |
| 4. | Lenka should be able to see the story title in balloon window. |
| | Show caption from corresponding story in a tooltip |

UC#9: Click through to story from dot on a chart

| | |
|---|---|
| 1. | Lenka login to a plant automation software platform (e.g., Wonderware ®) online site. |
| 2. | Lenka navigate to home page. |
| 3. | Lenka click on the chart under news feed tab, it takes him more granular details of the chart |
| | A popup will display complete details of story |
| | Select details from where _id = _id (mongo db id) |

UC#10: User adds new story by clicking on a line in a chart “this looks like a memory leak”

| 1. | Lenka opens line chart which represent memory consumption of historian server. | |
|---|---|---|
| 2. | She notices spike in the line chart. | |
| 3. | She right clicks on the spike and selected “Add story” option. | |
| 4. | “Create story” form opens. She enter the title “this looks like a memory leak” and the | |
| | associated description. | |
| 5. | The story gets added to news DB. | |
| | User can add story -the chart details can enable and/or facilitate a story: | |
| | source | source of the tag clicked on |
| | tagname | tagname of the tag clicked |
| | | on |
| | fqn | fqn of the tag clicked on |
| | algorithm | “chart_annotate” |
| | posted_datetime (currently | Current datetime |
| | datetime) | |
| | event_datetime | Datetime on line chart |
| | | where she added the story |
| | event_span | from and to dates of the |
| | | current viewing area of the |
| | | chart. |
| | location | Lenka's location from her |
| | | user profile OR location of |
| | | tag OR most restrictive of |
| | | the two (ask Michal) |
| | caption | Lenka types in a caption |
| | | “this looks like a memory |
| | | leak” |
| | body(html) | “Lenka added an |
| | | annotation to the chart for |
| | | Retrieval02.MemUsed |
| | | saying “this looks like a |
| | | memory leak”, [chart |
| | | image] [link to chart] |
| | tenant | Lenka's current tenant id |
| | | (from JWT, added by |
| | | system) |
| | timezone | Lenka's current time zone |
| | | “America/Los Angeles” |
| | units | Engineering units of tag |
| | tz | Lenka's current time zone |
| | | in short form “PST” |
| | user_id | User ID for Lenka |

UC#11: Show stories by location

| | |
|---|---|
| 1. | Lenka is user from “Lakeforest” |
| 2. | Lenka login to a plant automation software platform (e.g., Wonderware ®) online site. |
| 3. | Under news feed tab Lenka will see only stories visible from /LakeForest |

UC#12: Expand the story by clicking the more . . . button

| | |
|---|---|
| 1. | Lanka Navigates News Feed Tab in a plant automation software platform (e.g., |
| | Wonderware ®) online |
| 2. | Stories get listed with title and 2 or 3 lines of story details(Similar to face book comments). |
| 3. | Lanka clicks on More . . . button. It display more details/information of the story in line. |

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternative embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, by a computing device, data related to an operation by an asset at a location for a time period;
analyzing, by the computing device, the data, and based on said analysis, identifying anomaly information identified by the data;
causing to be displayed, via the computing device over a network, the anomaly information within a user interface (UI), the UI enabling interaction and input corresponding to the displayed anomaly information;
receiving, by the computing device, in response to display of the anomaly information within the UI, feedback, the feedback comprising information indicating a type of request in response to viewing the anomaly information within the UI;
analyzing, by the computing device, the anomaly information based on the feedback, and determining, based on said analysis, a story score, said story score corresponding to said operation at the location; and
causing an update, by the computing device, of the anomaly information displayed within the UI based on the determined story score, said update comprising an action that corresponds to a type of request indicated by the feedback.

2. The method of claim 1, further comprising:
determining, based on analysis of the anomaly information, attributes of the anomaly information identified via the feedback, wherein said story score is further based on said attributes.

3. The method of claim 1, further comprising:
receiving a second set of data related to another operation by the asset at the location; and
updating the story score based on the second set of data, wherein display of the second set of data is based at least in part on the feedback.

4. The method of claim 3, wherein said second set of data is received based on the feedback.

5. The method of claim 1, further comprising:
generating an electronic data object based on the identified anomaly information, the electronic data object comprising displayable and interactive information digitally representing at least the anomaly information.

6. The method of claim 5, wherein the type of electronic data object is based at least in part on a type of anomaly information, said type of anomaly information dictating how to display the anomaly information within the UI.

7. The method of claim 1, wherein said type of request indicated by the feedback comprises at least one of a like, dislike, reset or expand.

8. The method of claim 1, wherein said anomaly information comprises information related to at least one instance of the operation by the asset that caused an anomaly of data within the received data.

9. The method of claim 8, wherein the anomaly information further comprises additional information related to remaining data in the received data.

10. The method of claim 9, wherein said additional information comprises data and metadata related to at least one of the operation, a user, a team, the asset and the location.

11. The method of claim 1, wherein said feedback is provided by a user viewing the UI on a device of the user.

12. A non-transitory computer-readable storage medium tangibly encoded with computer-executable instructions, that when executed by a processor associated with a computing device, performs a method comprising:
receiving, by the computing device, data related to an operation by an asset at a location for a time period;
analyzing, by the computing device, the data, and based on said analysis, identifying anomaly information identified by the data;
causing to be displayed, via the computing device over a network, the anomaly information within a user interface (UI), the UI enabling interaction and input corresponding to the displayed anomaly information;
receiving, by the computing device, in response to display of the anomaly information within the UI, feedback, the feedback comprising information indicating a type of request in response to viewing the anomaly information within the UI;
analyzing, by the computing device, the anomaly information based on the feedback, and determining, based on said analysis, a story score, said story score corresponding to said operation at the location; and
causing an update, by the computing device, of the anomaly information displayed within the UI based on the determined story score, said update comprising an action that corresponds to a type of request indicated by the feedback.

13. The non-transitory computer-readable storage medium of claim 12, further comprising:
determining, based on analysis of the anomaly information, attributes of the anomaly information identified via the feedback, wherein said story score is further based on said attributes.

14. The non-transitory computer-readable storage medium of claim 12, further comprising:
receiving a second set of data related to another operation by the asset at the location; and
updating the story score based on the second set of data, wherein display of the second set of data is based at least in part on the feedback.

15. The non-transitory computer-readable storage medium of claim 14, wherein said second set of data is received based on the feedback.

16. The non-transitory computer-readable storage medium of claim 12, further comprising:
generating an electronic data object based on the identified anomaly information, the electronic data object comprising displayable and interactive information digitally representing at least the anomaly information, wherein the type of electronic data object is based at least in part on a type of anomaly information, said type of anomaly information dictating how to display the anomaly information within the UI.

17. The non-transitory computer-readable storage medium of claim 12, wherein said type of request indicated by the feedback comprises at least one of a like, dislike, reset or expand.

18. The non-transitory computer-readable storage medium of claim 12, wherein said anomaly information comprises information related to at least one instance of the operation by the asset that caused an anomaly of data within the received data, wherein the anomaly information further comprises additional information related to remaining data in the received data, wherein said additional information comprises data and metadata related to at least one of the operation, a user, a team, the asset and the location.

19. A computing device comprising:
a processor; and
a non-transitory computer-readable storage medium for tangibly storing thereon program logic for execution by the processor, the program logic comprising:
logic executed by the processor for receiving, by the computing device, data related to an operation by an asset at a location for a time period;
logic executed by the processor for analyzing, by the computing device, the data, and based on said analysis, identifying anomaly information identified by the data;
logic executed by the processor for causing to be displayed, via the computing device over a network, the anomaly information within a user interface (UI), the UI enabling interaction and input corresponding to the displayed anomaly information;
logic executed by the processor for receiving, by the computing device, in response to display of the anomaly information within the UI, feedback, the feedback comprising information indicating a type of request in response to viewing the anomaly information within the UI;
logic executed by the processor for analyzing, by the computing device, the anomaly information based on the feedback, and determining, based on said analysis, a story score, said story score corresponding to said operation at the location; and
logic executed by the processor for causing an update, by the computing device, of the anomaly information displayed within the UI based on the determined story score, said update comprising an action that corresponds to a type of request indicated by the feedback.

20. The computing device of claim 19, further comprising:
logic executed by the processor for determining, based on analysis of the anomaly information, attributes of the anomaly information identified via the feedback, wherein said story score is further based on said attributes.
